(19) United States
(12) Patent Application Publication
(10) Pub. No.: US 2026/0117424 A1
(43) Pub. Date: Apr. 30, 2026

(54) CARBON NANOTUBE COMPOSITE FIBER AND METHOD FOR MANUFACTURING THE SAME

(71) Applicant: KOREA INSTITUTE OF SCIENCE AND TECHNOLOGY, Seoul (KR)

(72) Inventors: Bon-Cheol KU, Seoul (KR); Dongju LEE, Seoul (KR); Junghwan KIM, Seoul (KR); Seo Gyun KIM, Seoul (KR); Nam Dong KIM, Seoul (KR); Junyeon HWANG, Seoul (KR); Nam Ho YOU, Seoul (KR); Dae-Yoon KIM, Seoul (KR); Jungwon KIM, Seoul (KR)

(21) Appl. No.: 18/991,180

(22) Filed: Dec. 20, 2024

(30) Foreign Application Priority Data
Oct. 28, 2024 (KR) 10-2024-0148819

(51) Int. Cl. D01F 1/09; C01B 32/174; C08K 3/04; D01F 6/76; H01G 11/36; H01G 11/38; H01M 4/62

(52) U.S. Cl. CPC D01F 1/09; C01B 32/174; C08K 3/041; D01F 6/76; H01M 4/625; C01B 2202/02; C01B 2202/22; C01B 2202/34; C01P 2002/85; C01P 2004/03; C01P 2004/04; C01P 2004/13; C01P 2006/40; C08K 2201/004; C08K 2201/011; D10B 2401/16; D10B 2505/00; H01G 11/36; H01G 11/38

(57) ABSTRACT

A carbon nanotube composite fiber according to the present invention includes: a carbon nanotube; and a conductive polymer covalently bonded to the carbon nanotube, in which the conductive polymer includes one or more selected from following Chemical Formulas 1 to 3:

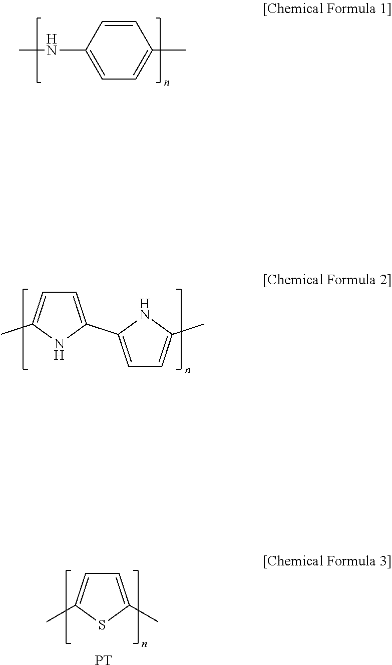

in Chemical Formulas 1 to 3, n is an integer equal to or larger than 1.

### CROSS-REFERENCE TO RELATED APPLICATION

This application claims priority to and the benefit of Korean Patent Application No. 10-2024-0148819 filed in the Korean Intellectual Property Office on Oct. 28, 2024, the entire contents of which are incorporated herein by reference.

### BACKGROUND OF THE INVENTION

### (a) Field of the Invention

The present invention relates to a carbon nanotube composite fiber with high capacitance, high energy density, high power density, and high durability, and a method for manufacturing the same.

### (b) Description of the Related Art

Carbon nanotubes or graphene oxide has excellent mechanical, thermal, and electrical characteristics. A fibrous aggregate of carbon nanotubes or graphene oxide fibers, existing as a continuous phase rather than as individual carbon nanotubes or graphene oxide, can be produced in fiber form as-is or woven into a fabric, and can be used in various ways. A carbon nanotube composite fiber has a density up to one-fifth the density of metals like copper and an electrical conductivity up to 10 times those of conventional carbon fibers, making it highly effective for producing materials that are lightweight, highly conductive, and strong, such as those used in the field of ultralight composite material field.

However, the carbon nanotube composite fiber has a problem in that its performance degrades when mixed and used with organic solvents.

To solve the above problem, the present inventors have developed a carbon nanotube composite fiber with strong polymer covalent bonds and a method for manufacturing the same.

### SUMMARY OF THE INVENTION

An embodiment of the present invention attempts to provide a carbon nanotube-polymer composite fiber and a method for manufacturing the same.

A carbon nanotube composite fiber according to an embodiment of the present invention includes a carbon nanotube; and a conductive polymer covalently bonded to the carbon nanotube, in which the conductive polymer includes one or more selected from following Chemical Formulas 1 to 3.

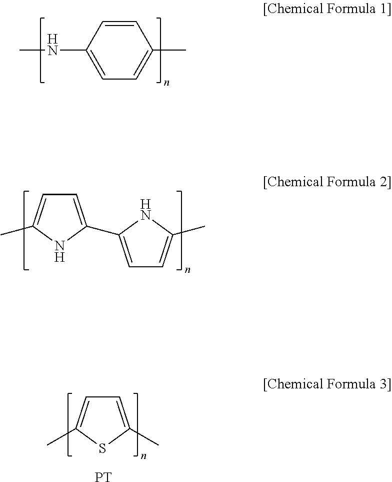

In Chemical Formulas 1 to 3, n is an integer equal to or larger than 1.

The conductive polymer may include one or more of a homopolymer, copolymer or substituted polymer having one or more structures of Chemical Formulas 1 to 3.

The conductive polymer may be included in an amount ranging from 1.0 to 60.0 wt % based on a total weight of the carbon nanotube composite fiber.

The carbon nanotube composite fiber may contain one or more doping elements selected from a nitrogen (N) element and a sulfur (S) element, and the doping element may be included in an amount ranging from 1.0 to 30.0 wt % based on a total weight of the carbon nanotube composite fiber.

The carbon nanotube composite fiber may have a density of 1.0 g/cm³ or higher.

An average length of the carbon nanotube may be 100 to 20,000 nm.

According to another embodiment of the present invention, a method for manufacturing a carbon nanotube composite fiber includes: preparing a carbon nanotube raw material; reacting the carbon nanotube raw material with a conductive polymer to obtain a carbon nanotube covalently bonded to the conductive polymer; forming a spinning dope obtained by dispersing the carbon nanotube covalently bonded to the conductive polymer in a solvent; and spinning the spinning dope to obtain a carbon nanotube composite fiber, in which the conductive polymer includes one or more selected from Chemical Formulas 1 to 3 above.

The conductive polymer may include one or more of a homopolymer, copolymer or substituted polymer having one or more structures of Chemical Formulas 1 to 3.

In the forming the spinning dope obtained by dispersing the carbon nanotube covalently bonded to the conductive polymer in the solvent, a carbon nanotube may be additionally mixed to form the spinning dope.

A weight ratio (W_{PgC}:W_{c}) of a weight (W_{PgC}) of the carbon nanotube covalently bonded to the conductive polymer and a weight (Wc) of the additional carbon nanotube raw material may be 1:99 to 60:40.

A weight average molecular weight of the conductive polymer may be in a range of 1,000 to 500,000 g/mol.

Another embodiment of the present invention provides an electrochemical element including the carbon nanotube composite fiber.

The electrochemical element may satisfy Relationship 1 in terms of energy density and power density based on a volume of the carbon nanotube composite fiber.

$$1. \times {10}^{5} \leq E . D * P . D \leq 1. \times {10}^{10} \qquad [ Relationship 1 ]$$

(here, E.D is an energy density based on the volume of the carbon nanotube composite fiber and has a unit of mWh/cm³, and P.D is a power density based on the volume of carbon nanotube composite fibers and has a unit of mW/cm³.)

The electrochemical element may have a specific capacitance of 10 F/g or higher calculated based on a weight of the carbon nanotube composite fiber.

The carbon nanotube composite fiber according to an embodiment of the present invention has excellent effects with improved capacitance, energy density, power density, and durability.

### BRIEF DESCRIPTION OF THE DRAWINGS

FIG. 1 schematically shows a process for manufacturing carbon nanotubes covalently bonded to a conductive polymer according to an embodiment of the present invention.

FIG. 2 shows an SEM image of a surface of a carbon nanotube composite fiber manufactured according to an embodiment of the present invention.

FIG. 3 shows a TEM image of a cross-section of the carbon nanotube composite fiber manufactured according to an embodiment of the present invention.

FIG. 4 shows SEM-EDX analysis results of the cross-section of the carbon nanotube composite fiber manufactured according to an embodiment of the present invention.

FIG. 5 shows tensile strength and tensile modulus analysis results of the carbon nanotube composite fiber manufactured according to an embodiment of the present invention.

FIG. 6 shows specific capacitance analysis results calculated by CV in a three-electrode system to which the carbon nanotube composite fiber manufactured according to an embodiment of the present invention is applied.

FIG. 7 shows specific capacitance analysis results calculated by GCD in the three-electrode system to which the carbon nanotube composite fiber manufactured according to an embodiment of the present invention is applied.

FIG. 8 shows energy density and power density analysis results of a cell to which the carbon nanotube composite fibers manufactured according to an embodiment of the present invention is applied.

FIG. 9 shows charge and discharge test results of the cell to which the carbon nanotube composite fiber manufactured according to an embodiment of the present invention is applied.

### DETAILED DESCRIPTION OF THE EMBODIMENTS

The terms such as first, second and third are used for describing, but are not limited to, various parts, components, regions, layers, and/or sections. These terms are used only to discriminate one part, component, region, layer or section from another part, component, region, layer or section. Therefore, a first part, component, region, layer or section described below may be referred to as a second part, component, region, layer or section without departing from the scope of the present invention.

The technical terms used herein are set forth only to mention specific embodiments and are not intended to limit the present invention. Singular forms used herein are intended to include the plural forms as long as phrases do not clearly indicate an opposite meaning. In the present specification, the term “including (comprising)” is intended to embody specific characteristics, regions, integers, steps, operations, elements and/or components, but is not intended to exclude presence or addition of other characteristics, regions, integers, steps, operations, elements, and/or components.

When a part is referred to as being “above” or “on” another part, it may be directly above or on the other part or an intervening part may also be present. In contrast, when a part is referred to as being “directly above” another part, there is no intervening part present.

Unless otherwise defined, all terms including technical and scientific terms used herein have the same meanings as the meanings generally understood by one skilled in the art to which the present invention pertains. Terms, such as those defined in commonly used dictionaries, are to be interpreted as having meanings consistent with the relevant technical literature and the present disclosure, and are not to be interpreted as having idealized or overly formal meanings unless expressly so defined herein.

In addition, unless otherwise stated, % means vol % (volume %), and 1 ppm is 0.0001 vol %.

In the present specification, the term “combination(s) thereof” included in the expression of the Markush format means one or more mixtures or combinations selected from the group consisting of the constituent elements described in the expression of the Markush format, and means including one or more selected from the group consisting of the constituent elements.

Hereinafter, embodiments of the present invention will be described in detail so that one skilled in the art to which the present invention pertains can easily implement the present invention. As those skilled in the art would realize, the described embodiments may be modified in various different ways, all without departing from the spirit or scope of the present invention.

### <Carbon Nanotube Composite Fiber>

An embodiment of the present invention provides a carbon nanotube composite fiber.

A carbon nanotube composite fiber according to an embodiment of the present invention may be one in which carbon nanotubes and a conductive polymer are covalently bonded, and specifically, one or more polymers selected from the following Chemical Formulas 1 to 3 may be covalently bonded.

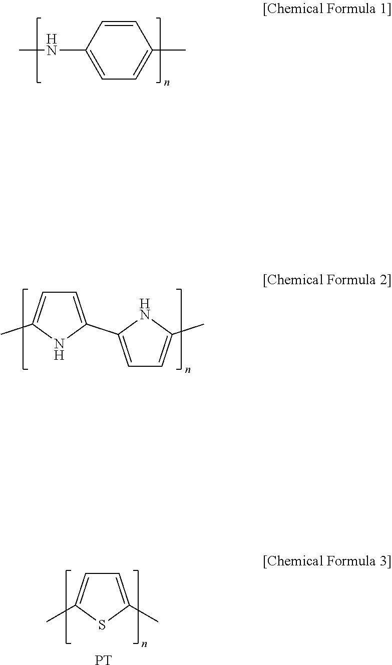

In Chemical Formulas 1 to 3, n is an integer equal to or larger than 1.

In the present invention, the conductive polymer may include one or more of a homopolymer, copolymer or substituted polymer having one or more structures of Chemical Formulas 1 to 3, and specifically may be polyaniline.

Note that the conductive polymer may be included in an amount ranging from 1.0 to 60 wt %, specifically from 5.0 to 50 wt % based on a total weight of the carbon nanotube composite fiber.

In the present invention, when the carbon nanotube composite fiber includes the conductive polymer within the above range, it is preferable as it can improve all of the capacitance, energy density, power density, and durability of the carbon nanotube composite fiber.

The carbon nanotubes may be axially oriented, and specifically, central axes of the carbon nanotubes may be oriented parallel or nearly parallel.

An intensity ratio (I_{G}/I_{D}) value of the G peak intensity (I_{G}) to the D peak intensity (I_{D}) in the Raman analysis spectrum of the carbon nanotube composite fiber may be 5 or greater, and specifically, may range from 5 to 200.

A tensile strength of the carbon nanotube composite fiber may be 0.1 to 3.5 GPa, specifically 1.0 to 2.5 GPa, or 1.0 to 2.2 GPa.

The carbon nanotube composite fiber may include one or more doping element selected from a nitrogen (N) element and a sulfur (S) element. The carbon nanotube composite fiber may include the doping element ranging from 0.5 to 20 wt %, 1 to 20 wt %, or 5 to 20 wt % based on the total weight.

The carbon nanotube composite fiber may have a density of 1.0 g/cm³ or higher ideally, and specifically 1.0 to 2.0 g/cm³, 1.5 to 2.0 g/cm³, or 1.7 to 2.0 g/cm³.

When the carbon nanotube composite fiber satisfies the above conditions, it is preferable as it is possible to achieve the desired physical property and electrochemical characteristics in the present invention and to enhance the energy density and power density per volume of an electrochemical element to which the carbon nanotube composite fiber is applied.

In the present invention, a diameter of the carbon nanotubes included in the carbon nanotube composite fiber may be 1 nm to 5 nm. Note that an aspect ratio of the carbon nanotube may be 100 or greater, and specifically, 100 to 20,000. More specifically, an average length of the nanotubes may be 100 to 10,000 nm.

When the diameter and length of the carbon nanotube satisfy the above ranges, it is preferable as the desired characteristics of the carbon nanotube composite fiber in the present invention can be expressed.

### <Method for Manufacturing Carbon Nanotube Composite Fiber>

Another embodiment of the present invention provides a method for manufacturing a carbon nanotube composite fiber.

According to another embodiment of the present invention, a method for manufacturing a carbon nanotube composite fiber includes the steps of: preparing a carbon nanotube raw material; reacting the carbon nanotube raw material with a conductive polymer to obtain carbon nanotubes covalently bonded to the conductive polymer; and spinning a spinning dope, obtained by dispersing the carbon nanotubes covalently bonded to the conductive polymer in a solvent, to obtain a carbon nanotube composite fiber.

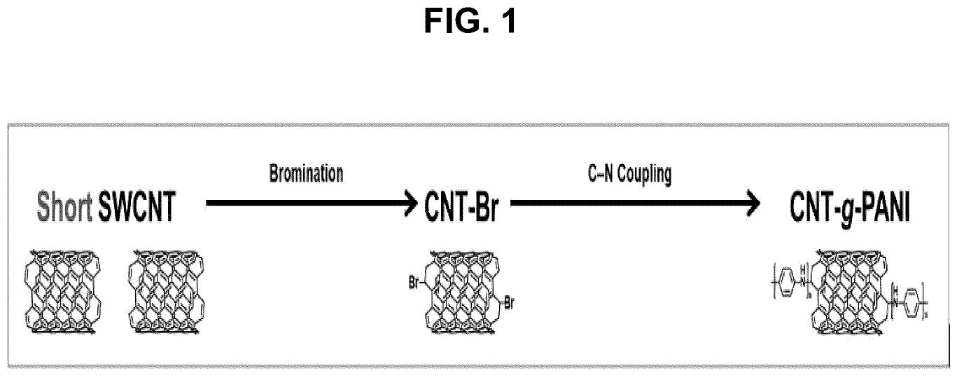

FIG. 1 illustratively shows the steps of preparing a carbon nanotube raw material and reacting the carbon nanotube raw material with a conductive polymer to obtain carbon nanotubes covalently bonded to the conductive polymer, according to the present invention.

Referring to FIG. 1, in the step of preparing a carbon nanotube raw material, carbon nanotubes may be subjected to a halogenation reaction (fluorine, chlorine, bromine, iodine) to form halogenated carbon nanotubes (CNT-X, where X is halogen).

In an embodiment of the present invention, before halogenating the carbon nanotubes, a step of purifying the carbon nanotubes may be performed first.

For the purification of carbon nanotubes, a method such as purification using an acid solution or purification by ultrasonic treatment may be used, and the specific method is not particularly limited as long as it can purify the carbon nanotubes to a level suitable for use as a raw material in the present invention.

In addition, in an embodiment of the present invention, the method of halogenating the carbon nanotubes is not particularly limited as long as the purified carbon nanotubes can be used to manufacture a desired carbon nanotube composite fiber by halogenating the carbon nanotubes.

In an embodiment of the present invention, a weight content of halogen in the halogenated carbon nanotubes may be 1.0 to 30.0 wt %, and specifically 5.0 to 20.0 wt %. When the halogenation concentration falls within the above range, it is preferable as the carbon nanotubes and conductive polymer described below can be efficiently covalently bonded to form a carbon nanotube composite fiber with excellent physical property and electrochemical characteristics.

The carbon nanotubes may include at least one selected from the group consisting of single-walled carbon nanotubes, double-walled carbon nanotubes, multi-walled carbon nanotubes, and a combination thereof. The multi-walled carbon nanotubes may have a wall number of 2 to 5.

An intensity ratio (I_{G}/I_{D}) value of the G peak intensity (I_{G}) to the D peak intensity (I_{D}) in the Raman analysis spectrum of the carbon nanotubes may be 5 or greater, and specifically, may range from 5 to 200, from 10 to 150, or from 20 to 100. When the intensity ratio (I_{G}/I_{D}) of the carbon nanotubes falls within the above range, it is preferable as it is possible to produce a carbon nanotube composite fiber with excellent physical property and electrochemical characteristics.

Next, a step of reacting the halogenated carbon nanotube (CNT-X) with a conductive polymer to obtain carbon nanotubes covalently bonded to the conductive polymer is performed.

The conductive polymer may be a polymer containing a nitrogen (N) element or a sulfur (S) element.

The conductive polymer may include one or more selected from the following Chemical Formulas 1 to 3, and specifically, may include one or more of a homopolymer, copolymer, or substituted polymer having one or more structures of the Chemical Formulas 1 to 3.

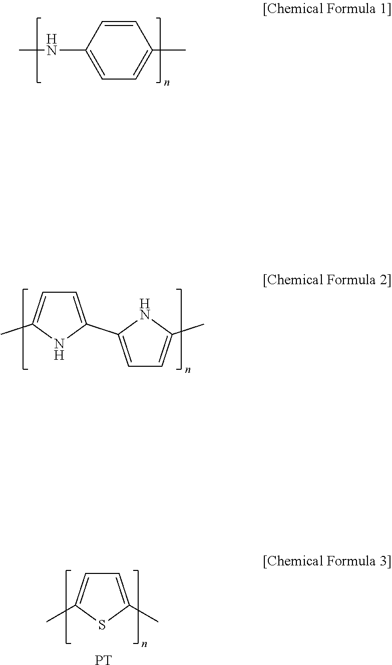

In Chemical Formulas 1 to 3, n is an integer equal to or larger than 1.

In an embodiment of the present invention, the conductive polymer may have a weight average molecular weight of 500 g/mol or more, specifically, 1,000 to 500,000 g/mol, or 5,000 to 150,000 g/mol.

In an embodiment of the present invention, the halogenated carbon nanotube (CNT-X) may be subjected to a reaction by adding the conductive polymer to an organic solvent and then performing heat treatment.

In an embodiment of the present invention, the organic solvent may be anhydrous dimethyl sulfoxide (DMSO).

In an embodiment of the present invention, the step of reacting the carbon nanotube raw material with a conductive polymer to obtain carbon nanotubes covalently bonded to the conductive polymer may be performed, and then a step of cleaning the carbon nanotubes covalently bonded to the conductive polymer may be performed.

The cleaning process may involve cleaning the carbon nanotubes covalently bonded to the conductive polymer one or more times using cleaning water including one or more selected from dimethyl sulfoxide (DMSO), deionized water, and acetone.

Next, a step of forming a spinning dope obtained by dispersing the carbon nanotubes covalently bonded to the conductive polymer in a solvent, and then spinning the spinning dope to obtain a carbon nanotube composite fiber is performed.

In an embodiment of the present invention, in the step of forming a spinning dope obtained by dispersing the carbon nanotubes covalently bonded to the conductive polymer in the solvent, a carbon nanotube raw material may be additionally mixed.

In an embodiment of the present invention, a weight ratio (W_{PgC}:W_{c}) of a weight (W_{PgC}) of the carbon nanotubes covalently bonded to the conductive polymer and a weight (W_{c}) of the additional carbon nanotube raw material may be 1:99 to 60:40, and specifically 5:95 to 55:45, or 5:95 to 50:50.

A length of the additionally mixed carbon nanotubes may be longer than a length of a unit carbon nanotube included in the carbon nanotubes covalently bonded to the conductive polymer, and specifically, may be 1.1 to 20 times longer, or 2 to 10 times longer.

In an embodiment of the present invention, the solvent is not particularly limited as long as it can uniformly disperse the carbon nanotubes covalently bonded to the conductive polymer. For example, the solvent may be a superacid solvent, and specifically, may be one or more selected from chlorosulfonic acid (CSA), sulfuric acid, oleum, fluorosulfonic acid, trifluoroacetic acid, trifluoromethanesulfonic acid, fluoroantimonic acid, and carborane acid.

A concentration of the carbon nanotubes covalently bonded to the conductive polymer in the spinning dope may be 1 to 100 mg/mL, specifically 5 to 20 mg/mL, or 5 to 15 mg/mL.

When the characteristics, stirring conditions, concentrations, and the like of each of the above materials are all satisfied, the carbon nanotubes covalently bonded to the conductive polymer in the spinning dope may exhibit a liquid crystal phase of a lyotropic nematic phase.

Since the lyotropic nematic phase is thus expressed, the orientation, bundling properties, and the like of the finally manufactured fiber are improved, enhancing characteristics such as specific strength and specific elastic modulus.

The step of spinning the spinning dope to obtain a carbon nanotube composite fiber may be performed using a method such as wet spinning or liquid crystal spinning, and specifically, may be performed using a liquid crystal spinning method.

In an embodiment of the present invention, the step of spinning the spinning dope to obtain a carbon nanotube composite fiber may include steps of: spinning the spinning dope to obtain a carbon nanotube composite fiber intermediate; drawing the carbon nanotube composite fiber intermediate; and coagulating the drawn intermediate.

The step of drawing the carbon nanotube composite fiber intermediate may be performed at a ratio of 1 to 10 or 1 to 6. When the drawing is performed at the above ratio, it is preferable as it is possible to manufacture a carbon nanotube composite fiber with excellent physical property and electrochemical characteristics.

The step of coagulating the drawn intermediate may involve putting the drawn carbon nanotube composite fiber intermediate into a coagulation bath or the like to coagulate it, thereby obtaining a coagulated carbon nanotube composite fiber.

Steps of cleaning and drying the coagulated carbon nanotube composite fiber may be further included. The cleaning step and the drying step may be performed using methods and conditions widely used in the technical field to which the present invention pertains. For example, the carbon nanotube composite fiber may be cleaned with a solvent such as acetone or water and then dried at a temperature of about 200° C. or lower.

In an embodiment of the invention, an electrochemical element or electrochemical device including the carbon nanotube composite fiber may be provided.

The electrochemical element or electrochemical device may be a lithium secondary battery, a supercapacitor, a fuel cell, an electrolysis device, a redox flow battery, or a solar cell, and may be manufactured using a general method known in the art, and its form is not particularly limited.

In an embodiment of the present invention, an energy density of the electrochemical element may be 10 mWh/cm³ or higher.

In an embodiment of the present invention, the electrochemical element including the carbon nanotube composite fiber may have a specific capacitance of 10 F/g or higher calculated based on the weight of the carbon nanotube composite fiber.

The electrochemical device including the carbon nanotube composite fiber may have a specific capacitance of 10 F/g or higher, specifically ranging from 10 to 300 F/g or from 30 to 200 F/g, calculated by CV based on the weight of the carbon nanotube composite fiber. More specifically, the specific capacitance may be in the range of 30 to 70 F/g, 50 to 200 F/g, or 60 to 145 F/g.

In an embodiment of the present invention, the electrochemical element including the carbon nanotube composite fiber may have a specific capacitance of 10 F/g or higher, specifically, 10 to 300 F/g, or 30 to 200 F/g, calculated by GCD based on the weight of the carbon nanotube composite fiber. More specifically, the specific capacitance may be in the range of 30 to 80 F/g, 70 to 190 F/g, or 60 to 145 F/g.

In an embodiment of the present invention, the electrochemical element including the carbon nanotube composite fiber may have a specific capacitance of 100 F/g or higher calculated based on a weight of the polymer included in the carbon nanotube composite fiber.

The electrochemical element including the carbon nanotube composite fiber may have a specific capacitance of 100 F/g or higher, specifically ranging from 100 to 1,500 F/g or 200 to 1,450 F/g, calculated by CV based on the weight of the polymer included in the carbon nanotube composite fiber. More specifically, the specific capacitance may be in the range of 200 to 1,200 F/g or 300 to 1,200 F/g.

The electrochemical element including the carbon nanotube composite fiber may have a specific capacitance of 100 F/g or higher, specifically ranging from 100 to 2,000 F/g or 200 to 1,900 F/g, calculated by GCD based on the weight of the polymer included in the carbon nanotube composite fiber. More specifically, the specific capacitance may be in the range of 200 to 1,100 F/g or 350 to 1,600 F/g.

In an embodiment of the present invention, a capacity retention rate after performing 100,000 cycles of charge and discharge based on the initial discharge capacity of the electrochemical device to which the carbon nanotube composite fiber is applied may be 90% or higher, specifically 99% or higher.

Note that the electrochemical element according to the present invention may satisfy the following relationship 1 in terms of energy density and power density based on a volume of the carbon nanotube composite fiber included therein.

$$1. \times {10}^{5} \leq E . D * P . D \leq 1. \times {10}^{10} \qquad [ Relationship 1 ]$$

(here, E.D is an energy density based on the volume of the carbon nanotube composite fiber and has a unit of mWh/cm³, and P.D is a power density based on the volume of carbon nanotube composite fibers and has a unit of mW/cm³.)

In the relationship 1, a value of E.D*P.D may be 1.0×10⁵ to 1.0×10¹⁰, specifically 5.0×10⁵ to 1.0×10⁹, or 8.0×10⁵ to 6.0×10⁸.

In an embodiment of the present invention, the energy density of the electrochemical element to which the carbon nanotube composite fiber is applied may be 30 mWh/cm³ or higher, specifically 30 to 450 mWh/cm³, or 35 to 425 mWh/cm³.

In an embodiment of the present invention, the power density of the electrochemical element to which the carbon nanotube composite fiber is applied may be 20,000 to 1,500,000 mW/cm³, specifically 21,000 to 1,415,000 mW/cm³.

The energy density (E.Dₘ) and power density (P.Dₘ) of the electrochemical element, to which the carbon nanotube composite fiber is applied, based on the weight of the carbon nanotube composite fiber may be calculated by the following equation.

$$E . {D}_{m} ( Wh / kg ) = \frac{1}{2} \times {C}_{s} \times {Δ V}^{2}$$

$$P . {D}_{m} ( W / kg ) = \frac{E}{Δ t}$$

Here, Cs represents a specific capacitance (F/g), V represents a measured voltage range (V), and t represents a discharge time (s) measured during the GCD.

The energy density (E.D) and power density (P.D) of the electrochemical element, to which the carbon nanotube composite fiber is applied, based on the volume of the carbon nanotube composite fiber may be calculated from the following equations using the density of the carbon nanotube fiber (p, g/cm³).

$$E . D ( mWh / {cm}^{3} ) = E . {D}_{m} * ρ$$

$$P . D ( Mw / {cm}^{3} ) = P . {D}_{m} * ρ$$

Below, preferred Examples of the present invention and Comparative Examples will be described. However, the following Examples are only preferred examples of the present invention, and the present invention is not limited to the following Examples.

### Preparation Example 1

Carbon nanotubes (PgC_1) covalently bonded to a polymer were prepared as follows.

Using Tuball™ (OcSiAl) single-walled carbon nanotubes @@@, purified single-walled carbon nanotubes (SWCNTs) with an average length of 100 to 10,000 nm were brominated to form brominated carbon nanotubes (CNT-Br) with a bromine content of about 13 wt %.

The aspect ratio (L/d) of carbon nanotubes can be measured according to the Onsager theory and calculated using the formula φ_{c}=3.34(L/d)⁻¹. A concentration at which the isotropic cloud point (pc) appears can be identified through a polarizing microscope by dispersing the carbon nanotubes in chlorosulfonic acid at a specific concentration.

1 equivalent or more of polyaniline (PANI) with a weight average molecular weight of 5,000 g/mol was introduced into the reactor based on the CNT-Br. Specifically, 1.5 equivalents of PANI were introduced based on the Br content of the CNT-Br. Additionally, CuI, K₂CO₃ and trans-4-hydroxy-L-proline were introduced into the reactor, nitrogen gas was flowed to form a nitrogen gas atmosphere inside the reactor, anhydrous DMSO was introduced into the reactor, and the reaction was carried out while heating at a temperature of 65° C. for 24 hours or longer.

After the reaction was completed, the materials inside the reactor were filtered through a PTFE filter (0.2 μm), and the residue was cleaned with DMSO, deionized water, and acetone, and then dried in a vacuum state at 80° C. for 10 hours or longer to obtain CNTs covalently bonded to the polymer. In this case, about 64 wt % of PANI was bonded based on the total weight of the carbon nanotubes and PANI.

### Preparation Example 2

Using PANI with a weight average molecular weight of 50,000 g/mol, CNT(PgC_2) covalently bonded to a polymer was obtained in which about 93 wt % of PANI based on the total weight of the carbon nanotubes and PANI was bonded.

### Preparation Example 3

Using PANI with a weight average molecular weight of 100,000 g/mol, CNT(PgC_3) covalently bonded to a polymer was obtained in which about 94 wt % of PANI based on the total weight of the carbon nanotubes and PANI was bonded.

### Embodiment 1

Mixed CNTs were formed by mixing CNT (PgC_1) covalently bonded to a polymer, which was prepared in Preparation Example 1, and long double-walled carbon nanotubes (DWCNTs) available from Meijo at a weight ratio of W_{PgC}:W_{c} of 5:95. An average length of the DWCNTs is 4.5 to 7 times an average length of the CNTs included in the CNTs covalently bonded to the polymer.

The mixed CNTs were dispersed in chlorosulfonic acid (CSA) at a concentration of 10 mg/mL for 20 hours or longer to prepare a spinning dope.

The prepared spinning dope was spun using a 25G needle having a diameter of 0.26 mm, and drawn at a draw ratio of 1.8 or higher. Acetone was used as the coagulation solution.

Next, the carbon nanotube composite fiber was finally prepared by drying in a vacuum oven at about 170° C. for a day or longer.

### Examples 2 to 18

Carbon nanotube composite fibers were prepared by changing the mixing ratio of CNTs covalently bonded to the polymer prepared according to Preparation Examples 1 to 3 and DWCNTs, and the raw materials and mixing ratios are shown in Table 1 below.

### Comparative Examples 1 to 5

Carbon nanotube composite fibers were prepared in the same manner as in Example 1, except that the spinning dope was prepared by additionally mixing PANI with a weight average molecular weight of 100,000 g/mol and double-walled carbon nanotubes (DWCNTs).

Table 2 below shows the weight ratios of PANI and DWCNT.

### Comparative Example 6

A carbon nanotube fiber was prepared in the same manner as in Comparative Example 1, except that no polymer was used in the carbon nanotube composite fiber and only carbon nanotubes were used.

TABLE 1

| | CNT | | Polymer |
|---|---|---|---|
| | covalently bonded | Weight | content (wt %) in |
| | to polymer | ratio | carbon nanotube |
| | (PgC) | PgC:DWCNT | composite fiber |
| Example 1 | PgC_1 | 5:95 | 3.2 |
| Example 2 | PgC_1 | 10:90 | 6.4 |
| Example 3 | PgC_1 | 20:80 | 12.8 |
| Example 4 | PgC_1 | 30:70 | 19.2 |
| Example 5 | PgC_1 | 40:60 | 25.6 |
| Example 6 | PgC_1 | 50:50 | 32 |
| Example 7 | PgC_2 | 5:95 | 4.65 |
| Example 8 | PgC_2 | 10:90 | 9.3 |
| Example 9 | PgC_2 | 20:80 | 18.6 |
| Example 10 | PgC_2 | 30:70 | 27.9 |
| Example 11 | PgC_2 | 40:60 | 37.2 |
| Example 12 | PgC_2 | 50:50 | 46.5 |
| Example 13 | PgC_3 | 5:95 | 4.7 |
| Example 14 | PgC_3 | 10:90 | 9.4 |
| Example 15 | PgC_3 | 20:80 | 18.8 |
| Example 16 | PgC_3 | 30:70 | 28.2 |
| Example 17 | PgC_3 | 40:60 | 37.6 |
| Example 18 | PgC_3 | 50:50 | 47 |

TABLE 2

| | Weight ratio | Polymer content (wt %) in carbon |
|---|---|---|
| | PANI:DWCNT | nanotube composite fiber |
| Comparative | 1:99 | 1.0% |
| Example 1 | | |
| Comparative | 3:97 | 3.0% |
| Example 2 | | |
| Comparative | 5:95 | 5.0% |
| Example 3 | | |
| Comparative | 7:93 | 7.0% |
| Example 4 | | |
| Comparative | 10:90 | 10.0% |
| Example 5 | | |
| Comparative | 0:100 | 0% |
| Example 6 | | |

### Evaluation Example 1: SEM Image Analysis

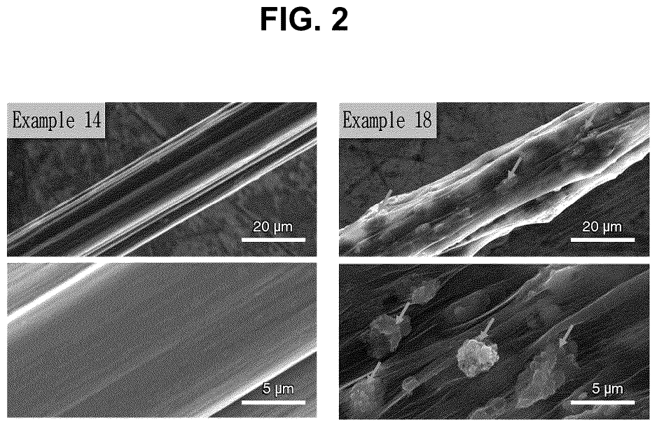

The surfaces of the carbon nanotube composite fibers prepared according to Examples 14 and 18 were observed using a scanning electron microscope (SEM) and are shown in FIG. 2.

Referring to FIG. 2, it can be confirmed that the polymer is located on the surface and inside of the carbon nanotube composite fibers prepared according to Examples 14 and 18.

### Evaluation Example 2: TEM Image Analysis

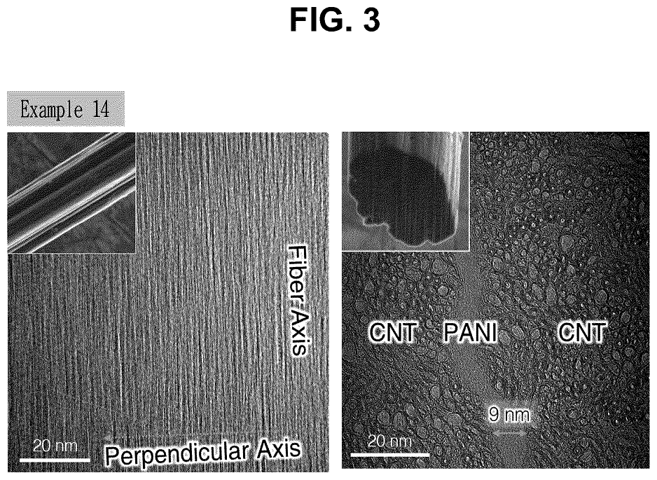

The cross-section of the carbon nanotube composite fiber prepared according to Example 14 was observed using a transmission electron microscope (TEM) and is shown in FIG. 3.

Referring to FIG. 3, it can be confirmed that the polymer is located between adjacent carbon nanotubes of the carbon nanotube composite fiber prepared according to Example 14.

### Evaluation Example 3: SEM-EDX Analysis

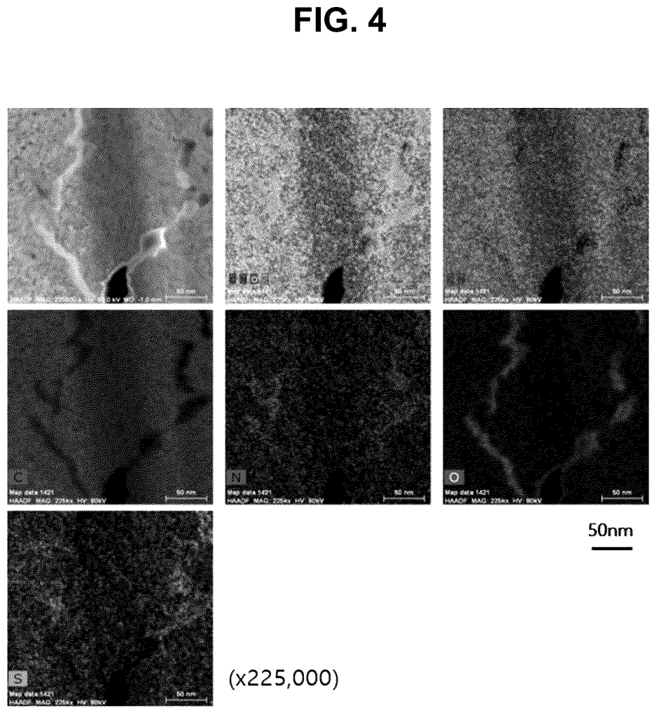

The cross-section of the carbon nanotube composite fiber prepared according to Example 14 was subjected to analysis using a scanning electron microscope-energy-dispersive X-ray spectroscopy (SEM-EDX), and the results are shown in FIG. 4.

Referring to FIG. 4, it can be confirmed that the carbon nanotube composite fiber prepared according to Example 14 contains C, N, O, and S, and the polymer is located between the carbon nanotubes.

### Evaluation Example 4: Tensile Strength and Tensile Modulus Analysis

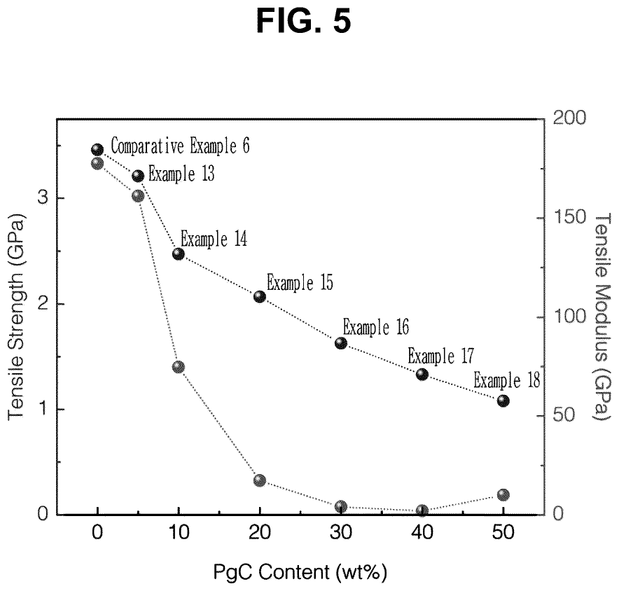

Tensile strength and tensile modulus of the carbon nanotube composite fibers prepared according to Examples 1 to 6 were measured using FAVIMAT+(single fiber physical property measuring apparatus), and the results are shown in FIG. 5.

### Evaluation Example 5: Specific Capacitance Analysis

Electrochemical characteristics were analyzed through cyclic voltammetry (CV) and galvanostatic charge-discharge (GCD) tests in a three-electrode system using the carbon nanotube composite fibers prepared according to the examples and comparative examples.

A 1 M sulfuric acid aqueous solution was used as an electrolyte, a platinum (Pt) plate was used as a counter electrode, and Ag/AgCl was used as a reference electrode. CV measurements were carried out in the range of 0.0 to 1.0 V and scan rates were 0.01, 0.03, 0.05, 0.07, and 0.1 V/s. GCD measurements were carried out at current densities of 1, 3, 5, 7, 10, 50, 100 A/g, and, similar to the CV measurements, were carried out in the range of 0.0 to 1.0 V.

For three-electrode measurements, 50 strands of carbon nanotube composite fibers prepared according to the above examples and comparative examples were fixed to a 5.5 cm long polytetrafluoroethylene (PTFE) holder. The fixed carbon nanotube composite fibers were subjected to CV and GCD analyses in the electrolyte, and the specific capacitance was calculated according to the following equation.

$$specific capacitance ( Cs ) = ( I \times Δ t ) / ( m \times Δ V )$$

Here, l represents a charge/discharge capacity (A), Δt represents a discharge time (s), m represents a mass (g) of the carbon nanotube composite fiber sample, and ΔV represents a voltage in CV and GCD measurements. In CV analysis, l and m were measured at a specific scan rate (V/s), and in GCD analysis, Δt and ΔV were measured at a specific current density (A/g).

The specific capacitance calculation results based on the weight of the carbon nanotube composite fiber and the weight of the polymer in the carbon nanotube composite fiber are shown in Table 4 below.

TABLE 4

| | Specific capacitance | | Specific capacitance | |
|---|---|---|---|---|
| | calculated by CV | | calculated by GCD | |
| | (F/g), (10 mV/s) | | (F/g), (1 A/g) | |
| | Based on | Based on | Based on | Based on |
| | CNT fiber | polymer weight | CNT fiber | polymer weight |
| | weight | in CNT fiber | weight | in CNT fiber |
| Example 1 | 32 | 998 | 33 | 1,017 |
| Example 2 | 33 | 512 | 36 | 557 |
| Example 3 | 38 | 296 | 40 | 313 |
| Example 4 | 46 | 242 | 55 | 288 |
| Example 5 | 56 | 217 | 68 | 265 |
| Example 6 | 65 | 203 | 79 | 246 |
| Example 7 | 55 | 1,187 | 73 | 1,568 |
| Example 8 | 58 | 624 | 74 | 793 |
| Example 9 | 124 | 667 | 166 | 892 |
| Example 10 | 138 | 496 | 144 | 516 |
| Example 11 | 194 | 522 | 182 | 490 |
| Example 12 | 171 | 367 | 172 | 369 |
| Example 13 | 64 | 1,359 | 88 | 1,872 |
| Example 14 | 132 | 1,404 | 161 | 1,714 |
| Example 15 | 112 | 598 | 120 | 638 |
| Example 16 | 140 | 495 | 154 | 546 |
| Example 17 | 130 | 345 | 136 | 363 |
| Example 18 | 131 | 279 | 131 | 278 |
| Comparative | 1.7 | — | — | — |
| Example1 | | | | |
| Comparative | 2.2 | — | — | — |
| Example2 | | | | |
| Comparative | 2.1 | — | — | — |
| Example3 | | | | |
| Comparative | 1.8 | — | — | — |
| Example4 | | | | |
| Comparative | 3.1 | — | — | — |
| Example5 | | | | |
| Comparative | 3.8 | — | 2.5 | — |
| Example6 | | | | |

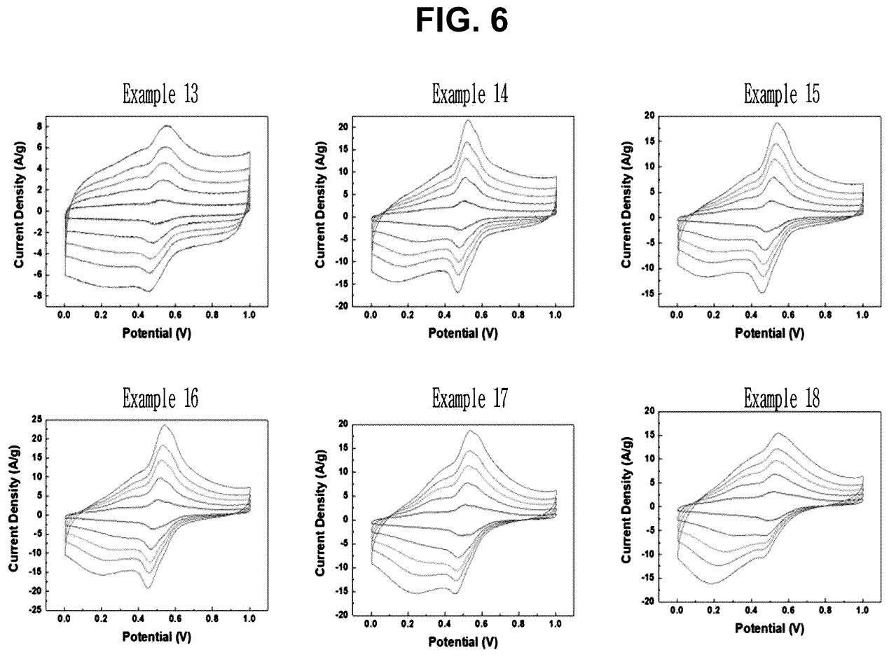

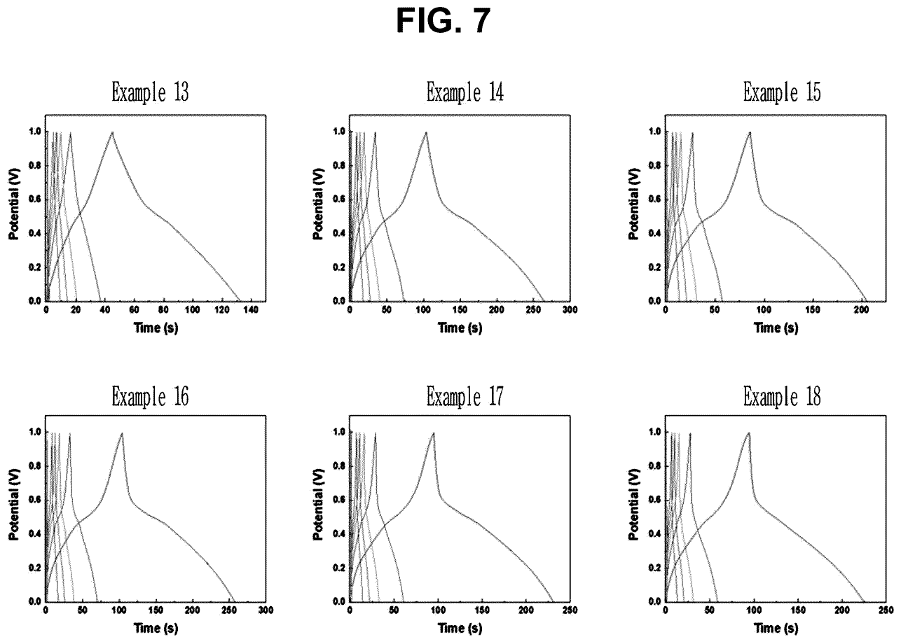

FIGS. 6 and 7 show the results measured using CV and GCD measurements for the carbon nanotube composite fibers prepared according to Examples 13 to 18. When the carbon nanotube composite fibers prepared according to Examples 13 to 18 were used, it was confirmed that the peaks of the redox reactions appearing in the pseudo-capacitor were distinctly observed because the polyaniline was covalently bonded and fixed to the carbon nanotubes.

Additionally, referring to Table 4, when the carbon nanotube composite fibers prepared according to Examples 1 to 18 were used, high specific capacitance was exhibited due to the polyaniline being covalently bonded, showing high electrochemical characteristics that were not observed in Comparative Examples 1 to 5.

### Evaluation Example 6: Density Analysis

Density analysis was conducted on the carbon nanotube composite fibers and the carbon nanotube fiber prepared according to Examples 1 to 18 and Comparative Example 6, and the results are shown in Table 5.

In the present invention, the density analysis was conducted using a density gradient tube. Using the density gradient tube, benzene and 1,1,2,2-tetrabromoethane were mixed to create a difference in the density of the solution, and a sample was placed in the solution to measure the density at that location. A reference density was established using a bead of known density, and the density of the sample was measured using the bead of known density as a reference.

TABLE 5

| | Density (g/cm³) |
|---|---|
| Example 1 | 1.95 |
| Example 2 | 1.94 |
| Example 3 | 1.92 |
| Example 4 | 1.86 |
| Example 5 | 1.79 |
| Example 6 | 1.75 |
| Example 7 | 1.97 |
| Example 8 | 1.95 |
| Example 9 | 1.94 |
| Example 10 | 1.86 |
| Example 11 | 1.80 |
| Example 12 | 1.74 |
| Example 13 | 1.97 |
| Example 14 | 1.96 |
| Example 15 | 1.94 |
| Example 16 | 1.87 |
| Example 17 | 1.80 |
| Example 18 | 1.75 |
| Comparative Example 6 | 2.04 |

### Evaluation Example 7: Energy Density and Power Density Analysis

A symmetrical two-electrode cell was fabricated using the carbon nanotube composite fiber prepared according to Example 14 above for both the positive and negative electrodes. The carbon nanotube composite fiber was fixed to a polyimide (PI) film, a polyvinyl alcohol (PVA)/sulfuric acid gel type electrolyte was applied to the fixed carbon nanotube composite fiber, and a polytetrafluoroethylene (PTFE) membrane filter was used as a separator. CV and GCD measurements were conducted over a wide potential range of 0.0 to 2.0 V, and based on these measurements, the energy density and power density based on the weight of the carbon nanotube composite fiber were calculated according to the following equations.

$$\begin{matrix}energy density ( Wh / kg ) = 1 / 2 \times Cs \times {( Δ V )}^{2} \\ electric power density ( W / kg ) = energy density / Δ t\end{matrix}$$

In addition, using the density of the carbon nanotube composite fiber measured above, the energy density, power density, and value of Relationship 1 of the cell were calculated based on the volume of the carbon nanotube composite fiber, and are shown in Table 6 below.

TABLE 6

| | energy | electric power | |
|---|---|---|---|
| | density | density | |
| | (E.D) | (P.D) | Relationship 1 |
| | (mWh/cm³) | (mW/cm³) | E.D * P.D |
| Example 1 | 301 | 584,138 | 1.8 × 10⁸ |
| Example 2 | 131 | 298,151 | 3.9 × 10⁷ |
| Example 3 | 88 | 109,843 | 9.7 × 10⁶ |
| Example 4 | 61 | 78,321 | 4.8 × 10⁶ |
| Example 5 | 53 | 43,158 | 2.3 × 10⁶ |
| Example 6 | 38 | 21,890 | 8.3 × 10⁵ |
| Example 7 | 223 | 669,841 | 1.5 × 10⁸ |
| Example 8 | 131 | 396,848 | 5.2 × 10⁷ |
| Example 9 | 91 | 148,964 | 1.4 × 10⁷ |
| Example 10 | 86 | 91,536 | 7.9 × 10⁶ |
| Example 11 | 71 | 84,169 | 6.0 × 10⁶ |
| Example 12 | 55 | 69,648 | 3.8 × 10⁶ |
| Example 13 | 341 | 557,865 | 1.9 × 10⁸ |
| Example 14 | 420 | 1,412,682 | 5.9 × 10⁸ |
| Example 15 | 122 | 234,197 | 2.9 × 10⁷ |
| Example 16 | 102 | 188,456 | 1.9 × 10⁷ |
| Example 17 | 66 | 69,864 | 4.6 × 10⁶ |
| Example 18 | 43 | 44,698 | 1.9 × 10⁶ |
| Comparative Example1 | — | — | — |
| Comparative Example2 | — | — | — |
| Comparative Example3 | — | — | — |
| Comparative Example4 | — | — | — |
| Comparative Example5 | — | — | — |
| Comparative Example6 | — | — | — |

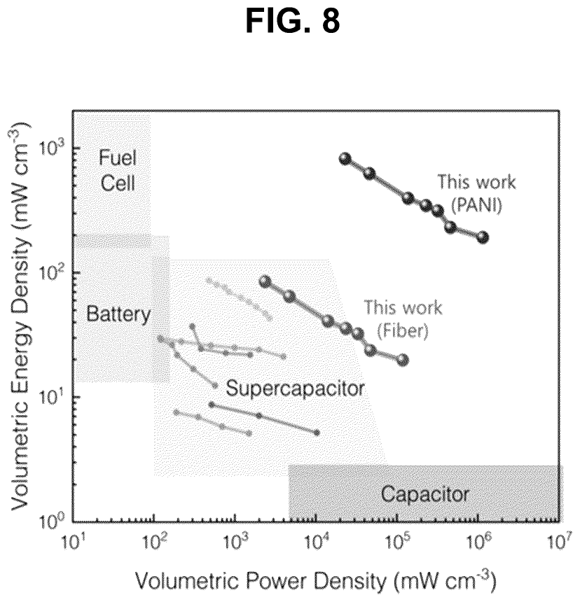

The calculated energy density and power density are shown in FIG. 8 in comparison with the results of previous studies. In FIG. 8, the graph named (PANI) represents the value calculated based on the weight of the polymer, i.e., PANI, in the carbon nanotube composite fiber, and the graph named (Fiber) represents the value calculated based on the weight of the carbon nanotube composite fiber.

The energy density and power density are indicated based on the values calculated based on the weight of polyaniline alone and the weight of the entire composite fiber. It is known that usual supercapacitors have high power density but low energy density, whereas batteries have high energy density but low power density.

In contrast, it was confirmed that the carbon nanotube composite fiber with covalently bonded polyaniline simultaneously has high energy density and power density.

### Evaluation Example 8: Stability Evaluation

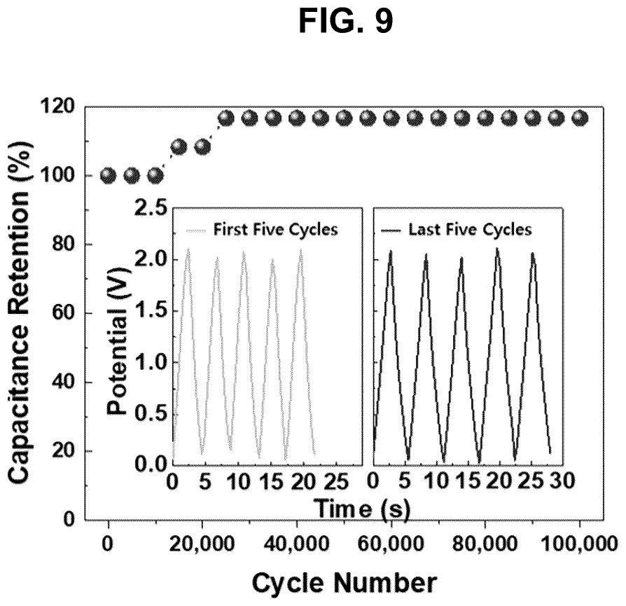

A symmetrical two-electrode cell was fabricated using the carbon nanotube composite fiber prepared according to Example 14 for both the positive and negative electrodes, and the stability test was conducted through repeated charging and discharging cycles. The results are shown in FIG. 9.

Referring to FIG. 9, for the cell using the carbon nanotube composite fiber prepared according to Example 14 in which polyaniline is covalently bonded, it can be confirmed that the capacity retention rate remains excellent even after 100,000 charge and discharge cycles.

That is, it can be confirmed that the covalent bond of the carbon nanotube composite fiber with covalently bonded polyaniline has a very strong bonding force, and the carbon nanotubes exhibit high strength, electrical conductivity, and thermal conductivity, resulting in high stability.

Additionally, referring to FIG. 9, when the specific capacitance of the first cycle was set to 100% and a total of 100,000 charge and discharge cycles were repeated, the capacity retention rate did not decrease at all but rather improved. This is considered to be because the gel-type electrolyte flows between the curved fibers as charging and discharging are repeated, and the internal polyaniline also participates in the reaction, resulting in an increase in the specific capacitance.

Note that for general secondary batteries, as charging and discharging are repeated, by-products are generated or the characteristics of the material itself deteriorate, resulting in a decrease in the charge and discharge performance.

While the present invention has been described in connection with what is presently considered to be practical exemplary embodiments, it is to be understood that the invention is not limited to the disclosed exemplary embodiments. On the contrary, it is intended to cover various modifications and equivalent arrangements included within the spirit and scope of the appended claims.

Therefore, it should be noted that the practical scope of the present invention is defined by the appended claims and equivalents thereof.

What is claimed is:

1. A carbon nanotube composite fiber comprising:
a carbon nanotube; and
a conductive polymer covalently bonded to the carbon nanotube, wherein
the conductive polymer comprises one or more selected from Chemical Formulas 1 to 3: 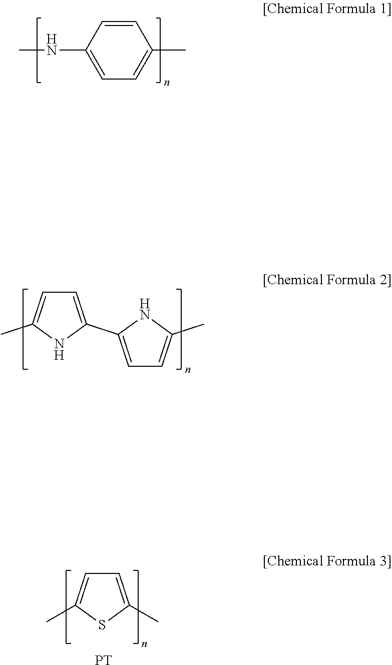
in Chemical Formulas 1 to 3, n is an integer equal to or larger than 1.

2. The carbon nanotube composite fiber of claim 1, wherein:
the conductive polymer comprises one or more of a homopolymer, copolymer or substituted polymer having one or more structures of Chemical Formulas 1 to 3.

3. The carbon nanotube composite fiber of claim 1, wherein:
the conductive polymer is included in an amount ranging from 1.0 to 60.0 wt % based on a total weight of the carbon nanotube composite fiber.

4. The carbon nanotube composite fiber of claim 1, wherein:
the carbon nanotube composite fiber contains one or more doping elements selected from a nitrogen (N) element and a sulfur (S) element, and
the doping element is included in an amount ranging from 1.0 to 30.0 wt % based on a total weight of the carbon nanotube composite fiber.

5. The carbon nanotube composite fiber of claim 1, wherein:
the carbon nanotube composite fiber has a density of 1.0 g/cm3 or higher.

6. The carbon nanotube composite fiber of claim 1, wherein:
an average length of the carbon nanotube is 100 to 20,000 nm.

7. A method for manufacturing a carbon nanotube composite fiber comprising:
preparing a carbon nanotube raw material;
reacting the carbon nanotube raw material with a conductive polymer to obtain a carbon nanotube covalently bonded to the conductive polymer;
forming a spinning dope obtained by dispersing the carbon nanotube covalently bonded to the conductive polymer in a solvent; and
spinning the spinning dope to obtain a carbon nanotube composite fiber, wherein
the conductive polymer comprises one or more selected from Chemical Formulas 1 to 3: 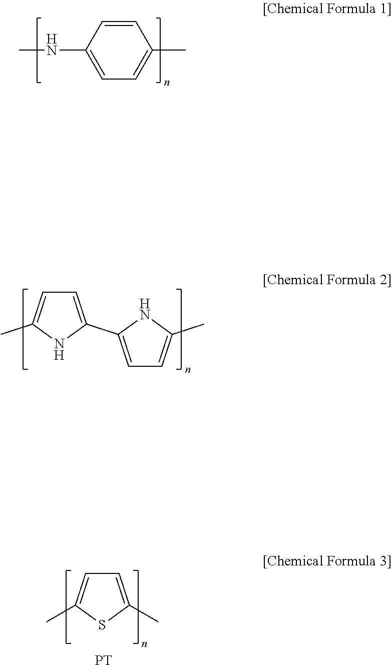
in Chemical Formulas 1 to 3, n is an integer equal to or larger than 1.

8. The method of claim 7, wherein:
the conductive polymer comprises one or more of a homopolymer, copolymer or substituted polymer having one or more structures of Chemical Formulas 1 to 3.

9. The method of claim 7, wherein:
in the forming the spinning dope obtained by dispersing the carbon nanotube covalently bonded to the conductive polymer in the solvent,
a carbon nanotube is additionally mixed to form the spinning dope.

10. The method of claim 9, wherein:
a weight ratio (WPgC:Wc) of a weight (WPgC) of the carbon nanotube covalently bonded to the conductive polymer and a weight (Wc) of the additional carbon nanotube raw material is 1:99 to 60:40.

11. The method of claim 7, wherein:
a weight average molecular weight of the conductive polymer is in a range of 1,000 to 500,000 g/mol.

12. The method of claim 7, wherein:
an average length of the carbon nanotube is 100 to 20,000 nm.

13. An electrochemical element comprising the carbon nanotube composite fiber of any one of claim 1.

14. The electrochemical element of claim 13, wherein:
an energy density and a power density based on a volume of the carbon nanotube composite fiber satisfy Relationship 1:
$$1. \times 105 \leq E . D * P . D \leq 1. \times 1010 \qquad [ Relationship 1 ]$$
here, E.D is an energy density based on the volume of the carbon nanotube composite fiber and has a unit of mWh/cm3, and P.D is a power density based on the volume of carbon nanotube composite fibers and has a unit of mW/cm³.

15. The electrochemical element of claim 14, wherein:
the electrochemical element has a specific capacitance of 10 F/g or higher calculated based on a weight of the carbon nanotube composite fiber.
